(19) United States
(12) Patent Application Publication
(10) Pub. No.: US 2014/0345727 A1
(43) Pub. Date: Nov. 27, 2014

(54) AUTOMATED DUMP SYSTEM FOR SOLID SEPARATOR

(71) Applicant: NATIONAL OILWELL VARCO, L.P., Houston, TX (US)

(72) Inventors: Terry Steven Gilmore, Granbury, TX (US); Peter Vincent Magnani, Humble, TX (US)

(73) Assignee: NATIONAL OILWELL VARCO, L.P., Houston, TX (US)

(21) Appl. No.: 13/899,164

(22) Filed: May 21, 2013

(51) Int. Cl. B01D 21/00; F16K 31/02; G05D 7/06

(52) U.S. Cl. CPC B01D 21/0024; G05D 7/0635; F16K 31/02
USPC 137/624.21

(57) ABSTRACT

An automated dump system for use with a solid removal system is herewith described. The system is for use in the oil and gas industry. The dump system comprises a programmable controller and valve(s) such as a plug valve and a choke valve, whereby the controller operates the valves at selected timings and if desired in a predetermined sequence. The valves maybe provided in separately removable segments. Additional components in the dump system may include pressure monitoring elements and an alarm condition signal. The system maybe mounted on a skid for ease of movement.

### BACKGROUND OF THE INVENTION

The present invention relates to a dump system for use with a solid removal system in the oil and gas industry

### SUMMARY OF THE INVENTION

In oil and gas drilling systems it is common to have to provide traps for removing solids from the recovered oil or gas so that subsequent components within the system are not contaminated by such solids and potentially dumped by them. Such solids are often in the form of particulate material, such as sand and mud and are therefore highly damaging to many components as well as providing the possibility of contamination of the system causing clogging and damage to valves and other flow components. For such reasons it is common to employ a particulate trap, often called a “sand trap” which sits in an early stage of fluid flow in order to remove sand and mud from the system and reduce its erosional effect. Such traps operate under a wide range of principles but generally require significant changes in flow direction and/or pressure to separate out the solid material. Such traps can require a specific or varying frequency of emptying. This removal of solids is done from time to time to ensure operation of the trap at maximum capacity. How often they need emptying varies, however, dependent upon where they are in their operating cycle. For example, at start up there is commonly a significant amount of solids which require removal, but under steady operation the solid build-up is often not as great, requiring a less frequent removal.

The removal of solids is usually performed by a manual dumping process which requires the opening and shutting of manual removal valves under significant pressure which can have safety implications for the operators. Liquid level controllers have been proposed to determine levels within such traps and then operate a dump valve to remove elected solids to overcome this. However, passage of the solids through the dump valves can cause erosion and a liquid level controller itself can readily become clogged with solid material, causing malfunction. For this reason, either approach to solids removal tends to require 24 hour attendance by maintenance personnel for smooth and reliable operation.

The present invention seeks to improve the operation of dumping systems for use with such solids traps to improve their reliability as well as address safety.

According to the present invention there will be provided a solids dump system for connection to a solids removal system for removing solids from the flow in a hydrocarbon processing facility, the dump system comprising: a programmable controller; and at least one valve connected to the outlet of the solids removal system, wherein the programmable controller is arranged to operate the valve(s) at selected timings during operating the removal system.

With the present invention it is possible to vary the timing of the solids removal cycle dependent upon the operating cycle of the trap and the well system as a whole such that there is not excessive build-up of solids material within the trap yet also it is possible to avoid excessive operation of the dumping system. Furthermore, by automating the control of dumping of solids from the trap in a manner which does not require internal monitoring of levels it is possible to provide a system with a significantly reduced maintenance requirement avoiding the need for onsite personnel to be in attendance around the clock. Furthermore, by appropriate monitoring of the valves within the dump system any problems with a system can be detected at an early stage, allowing overriding safety systems to be operated without causing safety concerns,

Furthermore, with the present invention it is possible to provide a completely automated dumping system that can be powered independently with low power requirements such as those can be provided by a solar energy system to yet further improve simplicity of installation and operation such that remote automated operation without user intervention is possible, particularly if two dumping systems are operated in parallel, one taking over from the other if an alarm condition is detected.

An example of the present invention will now be described with reference to the accompanying drawings, in which:

### BRIEF DESCRIPTION OF THE DRAWINGS

FIG. 1 is a schematic diagram of the system of the present invention for attachment to a known solids trap; and

FIG. 2 is a flow diagram showing the operation of the system of the invention.

### DETAIL DESCRIPTION OF THE EMBODIMENTS

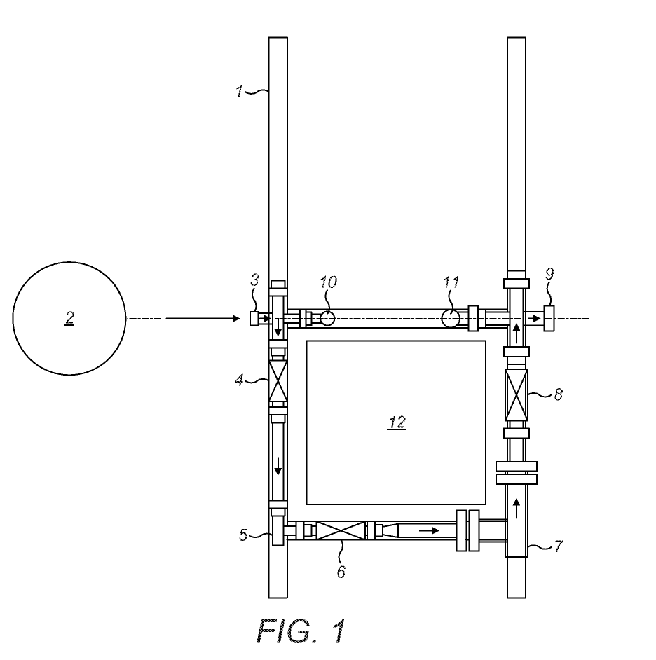

Referring to FIG. 1, a dump system 1 according to the present invention there is arranged to be attached, in use, to a sand trap vessel 2. The dump system I has an inlet connector 3 which connects to an outlet (not shown) of the sand trap vessel 2 via a relatively standard union-style connector, The inlet 3 of the dump system 1 is connected to a manually operated isolation valve 4 which in turn is connected via pipework 5 to an automated isolation valve 6. The automated isolation valve 6 is then connected to an automated choke 7 and this is in turn connected to a manually operated isolation valve 8. The outlet of the manually operated isolation valve 8 is connected to an outlet 9 from the dump system, that outlet 9 normally being connected, in use to a storage tank or pit into which solids are passed. Again, the outlet 9 may be connected to any further components via a union-style connector for ease and standardisation of connection. Upstream and downstream pressure transmitters 10,11 are provided to provide an indication of pressure at the inlet 3 and outlet 9 to a control component 12. The control component 12 is arranged to receive data from the upstream and downstream pressure transmitters 10,11, as well as time information from a clock and programmable control data from an operator or operating system. In turn the programmable control component 12 provides control output to the automated isolation valve 6 and automated choke 7 to provide optimised operation of the dump system 1 as will be described below.

The whole system 1 can be mounted on a movable skid (not shown) for ease of movement from site to site as well as for ease of installation. This also ensures a small footprint for the device.

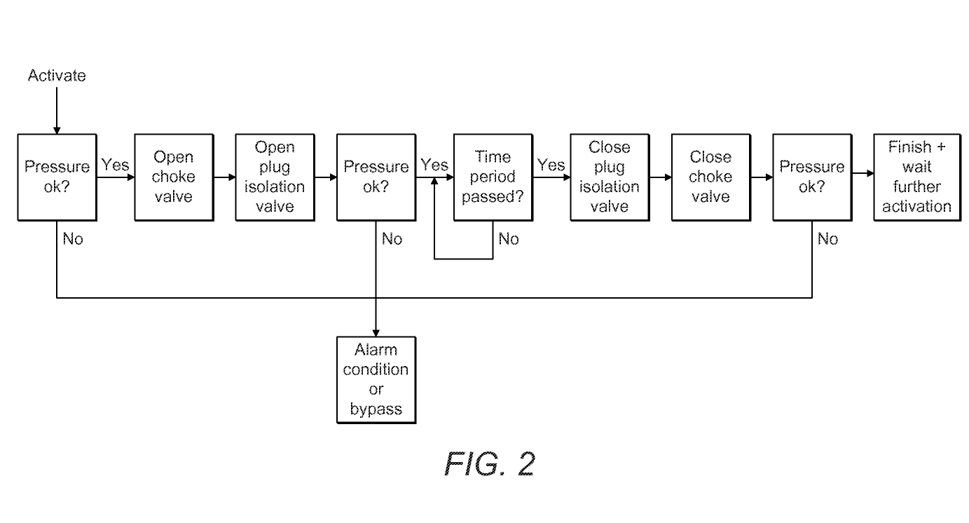

Referring to FIG. 2, the operation of the dump system 1 will now be described as it goes through the process of emptying solids such as sand and mud from the sand trap vessel 2.

At a first stage an activation trigger is provided to the programmable controller either via a timer after a predetermined time period, or by an activation component triggered by initial start-up of the sand trap vessel 2. The programmable controller 12 then monitors the upstream and downstream pressures to ensure that they are at acceptable values, If they are not at acceptable values then a fault indication can be provided to an operator.

If the pressures are at acceptable values the program controller controls the automated isolation valve 6 and choke valve 7 to allow material to be passed out from the sand trap vessel 2 through the dump system 1 and out of the outlet 9.

The cycle opens by the opening of the choke valve 7 followed by the opening of plug valve 6. The upstream and downstream pressures are monitored and an increase in pressure should be seen on the downstream pressure monitor 11. If this does not happen than an alarm condition is indicated. After a predetermined period (for example 1 minute) the plug isolation valve 6 is then closed followed by the choke valve 7. Again, pressures are monitored and a pressure drop should be seen on the downstream pressure sensor 11. Again, if this is not the case then an alarm condition is indicated.

The system may be configured such that a secondary dump system is provided and attached in parallel to the outlet of the sand trap vessel 2. Under alarm conditions the programmable controller 12 can then be configured to direct flow via an additional valve (not shown) to the second dump system so that operation is uninterrupted until a manual investigation of the alarm condition can be provided.

As may be appreciated, there are benefits in using a choke valve 7 as opposed to other forms of valve in the system of the present invention. A choke valve 7 is particularly suited to controlling pressure drop and velocity downstream of the choke valve, ensuring optimised operation of the system.

To enable good maintenance of the system the manual valve 4 and manual valve 8 are provided to allow cut-off of the system during repair and replacement of the other components such as the automated choke and plug valves 7,6. Furthermore, by using interconnections between individual components which are straightforward in the form of union connections, it is possible to develop a system which is relatively standardised and in which components can be removed and replaced relatively easily improving use of maintenance and operation.

With the present invention it is therefore possible to provide a dump system 1 for solids from a trap vessel 2 which requires minimal manual intervention and ensures continuous operation of the dumping of the contents of the trap vessel 2 without the need for continuous attendance by an operator. It also improves the overall safety of the system by avoiding the need for manual operation of dumping valves from the trap vessel 2 and therefore the exposure of manual operators to high pressure valves. In addition, by providing a system which can be supplied on a skid and with a low footprint size it is possible to provide automated dumping without the need for a large area or complex installation.

A person skill in the art understands that various permutations of the dump system of the current invention are within the scope of the invention. Accordingly, various embodiments of the dump system can include one or more of the various components described above in one of many combinations.

What is claimed is:

1. A solids dump system for connection, in use, to a solids removal system for removing solids from the flow in a hydrocarbon processing facility, the dump system comprising:
an inlet;
a programmable controller;
at least one valve connected to the outlet of the solids removal system and
an outlet,
wherein the programmable controller is arranged to operate the valve at selected timings during operation of the removal system.

2. The dump system of claim 1, wherein the dump system comprises at least two valves, a plug valve and a choke valve, positioned downstream from the plug valve, both of which are arranged to be controlled by the programmable controller.

3. The dump system of claim 2, wherein the programmable controller is arranged to operate the plug valve and the choke valve in a predetermined sequence in which the choke valve is first opened followed by the opening of the plug valve, and then after a predetermined period the plug valve is then closed and the choke valve subsequently closed.

4. The dump system of claim 1 further comprising an upstream pressure monitoring component for the inlet of the dump system and a downstream pressure monitoring component for the outlet of the dump system, and wherein the programmable controller is arranged to receive the outputs of the monitoring components to determine correct operation of the system and trigger an alarm condition signal if an erroneous pressure is detected by either or both monitoring components.

5. The dump system of claim 4, wherein the alarm signal triggers a diverting valve which diverts the outlet of the solids removal system to an alternative dump system.

6. The dump system of claim 1 further comprising one or more manual closing valves positioned within the flow of the dump system and arranged to allow manual closure of the system for maintenance.

7. The dump system of claim 1, wherein the valve is provided in a separately removable segment for ease of maintenance and repair.

8. The dump system of claim 1 further comprising a skid onto which the system is mounted for ease of movement.

9. The dump system of claim 1 wherein at least one of the inlet and outlet of the system is provided with a union connector for connection to other components in a simple and standardised manner.
